(19) United States
(12) Patent Application Publication
(10) Pub. No.: US 2013/0297336 A1
(43) Pub. Date: Nov. 7, 2013

(54) Healthcare Data Analysis

(71) Applicants: Ron R. Sanderson, Honolulu, HI (US); Stefan Fedusiv, Honolulu, HI (US)

(72) Inventors: Ron R. Sanderson, Honolulu, HI (US); Stefan Fedusiv, Honolulu, HI (US)

(73) Assignee: DATA DIAGNOSTIX, LLC, Honolulu, HI (US)

(21) Appl. No.: 13/874,100

(22) Filed: Apr. 30, 2013

Related U.S. Application Data
(60) Provisional application No. 61/641,294, filed on May 1, 2012.

(51) Int. Cl. G06Q 10/06; G06Q 50/22

(52) U.S. Cl. CPC G06Q 10/06; G06Q 50/22
USPC 705/2

(57) ABSTRACT

In accordance with the teachings provided herein, a system can capture data on ventilator length of stay (LOS) into a ventilator LOS data repository and analyze the data using various methods to determine ventilator Length of Stay (LOS) benchmarks. Advantageously, hospitals can analyze their own ventilator use in comparison with benchmarks from a range of scopes.

### RELATED APPLICATIONS

This Application claims priority to U.S. Provisional Patent Application No. 61/641,294, filed May 1, 2012, and entitled “System and Method for Healthcare Data Analysis” by Ron Sanderson and Stefan Fedusiv, which is incorporated herein by reference.

### BACKGROUND

A medical ventilator is a machine that performs the act of breathing by moving air into and out of the lungs on behalf of an incapacitated person. Ventilators are widely used in the intensive care unit (ICU) in healthcare facilities to prevent the death of patients that are unable to breathe.

A ventilator is commonly classified as a life support system and often has associated costs in the range of $2,000.00 to $5,000.00 per day of operation, Additionally, there are risks associated with use of a ventilator, not the least of which is Ventilator Associated Pneumonia (VAP), a life threatening condition.

However, use of a ventilator is often not analyzed. As a result, patients are often left on ventilators for longer than ideal amounts of time. The resulting length of stay can expose the patient to risk and can cost the hospital, government, and patient significant amounts of money.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

In accordance with the teachings provided herein, a system can capture data on ventilator length of stay into a ventilator length of stay (LOS) data repository. The data can be aggregated from numerous healthcare facilities. The system can then analyze the data using various methods to create ventilator LOS data reports using ventilator LOS as a dependent variable.

Various reports can be generated, including, for example, querying data over all participants, average LOS, by medical center size, by whether the hospital is a teaching hospital or not, by State, by corporate grouping, by total ventilator hours, by total ventilator days, by average ventilator LOS, by average ventilator LOS, by LOS by physician, by LOS by gender, by LOS by ICU type, by LOS>48 hours, ventilator discontinuation by time of day and day of week, and by any known or convenient other basis for generating the report.

Advantageously, healthcare facilities cart analyze their own ventilator use in comparison with benchmarks from a range of measures and interventions, independent variables.

### BRIEF DESCRIPTION OF THE DRAWINGS

FIG. 1 depicts an example of a system for performing healthcare data analysis

FIG. 2 depicts an example of a system including components for a ventilator LOS data management system.

FIG. 3 depicts a flowchart of an example of a method for collecting ventilator LOS data.

FIG. 4 depicts a flowchart of an example of a method for preparing reports of ventilator LOS data.

FIG. 5 depicts an example of a system for performing healthcare data analysis.

FIG. 6A depicts a graph of a number of ventilator events.

FIG. 6B depicts a graph of a number of ventilator events.

FIG. 7A depicts a graph of a number of events by physician.

FIG. 7B depicts a chart of average ventilator length of stay.

FIG. 7C depicts a chart of patient data.

FIG. 8A depicts a graph of total length of stay.

FIG. 8B depicts a graph of number of ventilator discontinuations by day of week.

FIG. 9A depicts a chart of number of ventilator discontinuations by hour of the day.

FIG. 9B depicts a chart of number of events by Age Group.

FIG. 10A depicts a chart of number of events by diagnosis code.

FIG. 10B depicts a chart of disposition of patient disposition following use of a ventilator.

FIG. 11A depicts an example of a chart of patient disposition following use of a ventilator.

FIG. 11B depicts an example of a chart of average length of stay by ICU type.

FIG. 11C depicts an example of a chart of average length of stay by age group.

FIG. 12A depicts an example of a chart of average length of stay by age group.

FIG. 12B depicts an example of a chart of average length of stay by diagnosis code.

FIG. 13A depicts an example of a chart of average length of stay by gender.

FIG. 13B depicts an example of a chart of average length of stay by physician.

FIG. 14A depicts an example of average length of stay by a user defined independent variable.

FIG. 14B depicts an example of average length of stay by a user defined independent variable.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

Ventilator LOS can be used as a dependent variable. That is it is assumed that the length of time that a patient spends on a ventilator depends on one or more other variables, for example, treating physician, healthcare facility, patient diagnosis, patient age, patient gender, healthcare policy, medical procedure, patient condition, change in patient management protocol, type of ventilator, ventilator mode or setting, or any known or convenient variable that may affect a patient on a ventilator.

Considering the time that a patient spends on a ventilator in relation to the independent variable can help to define trends. These trends can provide insight to the people, places, policy, or other items that affect the amount of time that the patient is on the ventilator. Analysis can uncover areas for improvement leading to improved ventilator management. Through these efforts risk to patients can be minimized and time and money can be saved.

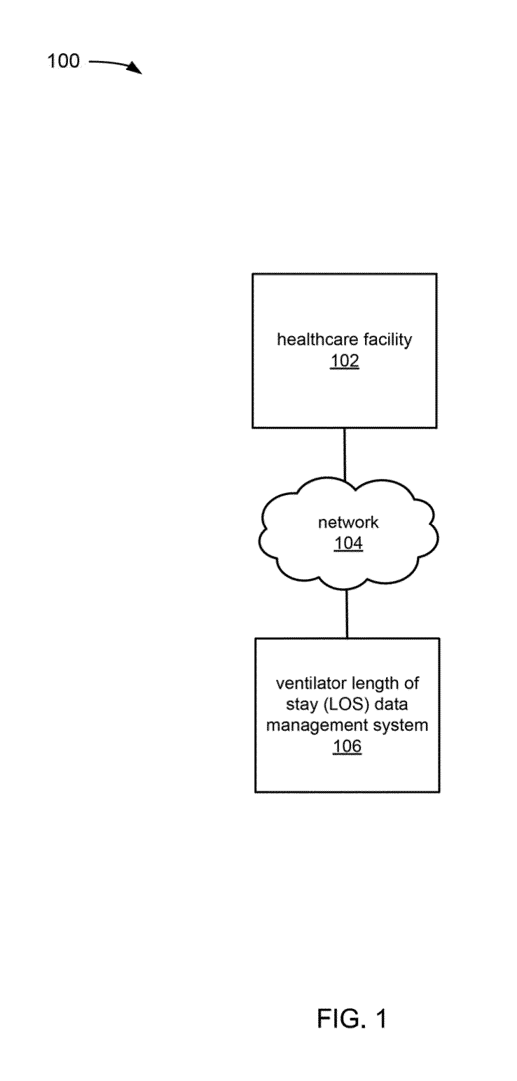

FIG. 1 depicts an example of a system 100 for performing healthcare data analysis. FIG. 1 includes healthcare facility 102, network 104 and ventilator length of stay (LOS) data management system 106.

In the example of FIG. 1, healthcare facility 102 can be a hospital, long term care facility, or any known or convenient organization that uses ventilators and therefore produces and collecting ventilator LOS data.

In the example of FIG. 1, network 104 can be practically any type of communications network, such as, by way of example but not limitation, the Internet or an infrastructure network. The term “Internet” as used herein refers to a network of networks which uses certain protocols, such as the TCP/IP protocol, and possibly other protocols such as the hypertext transfer protocol (HTTP) and secure hypertext transfer protocol (HTTPS) for, e.g. hypertext markup language (HTML) documents, extensible markup language (XML) documents, extensible hypertext markup language (XHTML) documents, and documents based on other languages that make up the World Wide Web (the web).

In the example of FIG. 1, ventilator length of stay (LOS) data management system 106 can be a computer implemented system operable to collect ventilator LOS data via network 104 and analyze the data for use in generating reports on ventilator LOS.

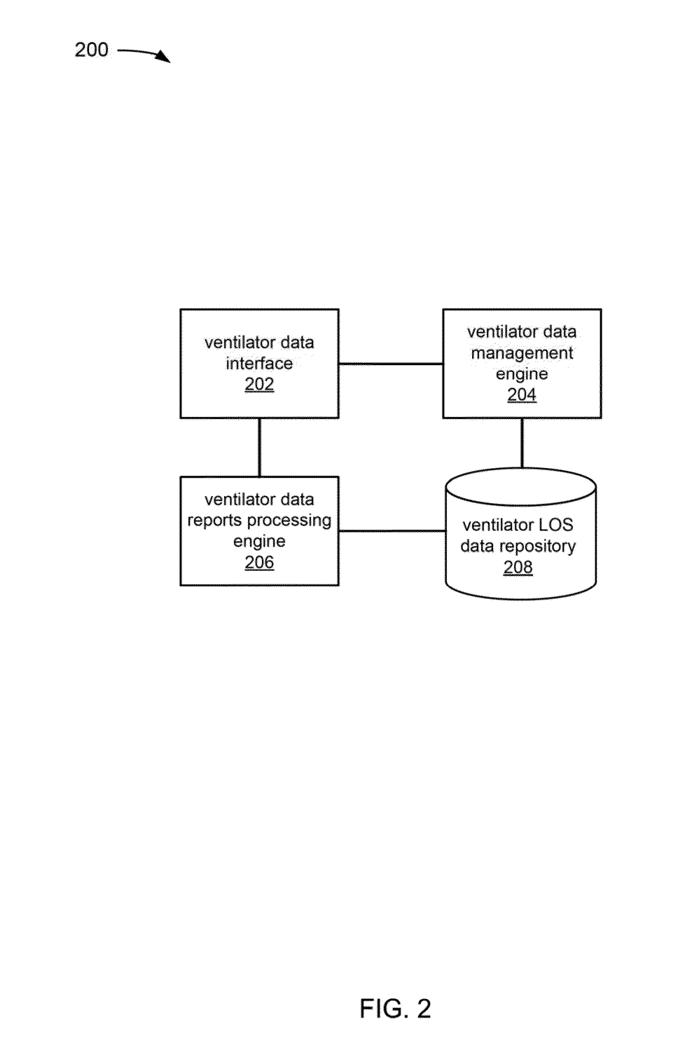

FIG. 2 depicts an example of a system 200 including components included in a ventilator LOS data management system. FIG. 2 includes ventilator data interface 202, ventilator data management engine 204, ventilator data reports processing engine 206 and ventilator LOS data repository 208. Such components may be combined with other components and/or re-organized into different configurations to satisfy the requirements of various particular implementations.

In the example of FIG. 2, ventilator data interface 202 can be implemented as instructions stored in a tangible, non-transitory, memory medium and executed on a processor coupled to the memory. The interface 202 can be used to transfer data into a system associated with the interface. Alternatively, the interface 202 can be used to transfer data out of a system associated with the interface. For example, the interface 202 can be implemented in HTML, XML, XHTML or any other convenient language to transfer reports to customers and to receive data from customers.

In the example of FIG. 2, ventilator data management engine 204 can be implemented as instructions stored in a tangible, non-transitory, memory medium and executed on a processor coupled to the memory. Particularly, the ventilator data management engine 204 can include instructions operable to parse incoming data for storage in a repository. Such data can be organized into relevant data structures, data tables, or other known or convenient data units.

In the example of FIG. 2, ventilator data reports processing engine 206 can be implemented as instructions stored in a tangible, non-transitory, memory medium and executed on a processor coupled to the memory. The ventilator data reports processing engine 206 can retrieve and analyze data from a repository including organizing the data into human readable and/or aesthetically pleasing format(s) based on one or more criteria specifying the content and/or format(s) of the report(s).

In the example of FIG. 2, ventilator LOS data repository 208 can be a data repository for storing information. As used in this paper, a “repository” can be implemented, for example, as software embodied in a physical computer-readable medium on a general-purpose or specific-purpose machine, in firmware, in hardware, in a combination thereof, or in any applicable known or convenient device or system.

The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and OpenOffice.org Base, to name several, however, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 2, in operation, the ventilator data interface 202 receives ventilator LOS data from a computing system associated with a healthcare facility. The ventilator data interface 202 provides the ventilator LOS data to the ventilator data management engine 204 which then parses and stores the ventilator LOS data into the ventilator LOS data repository 208.

Upon request from a customer, or if automatically generated, ventilator data reports processing engine 206 retrieves data from the ventilator LOS data repository 208 and prepares one or more reports in accordance with the requirements of the customer or process requesting the report.

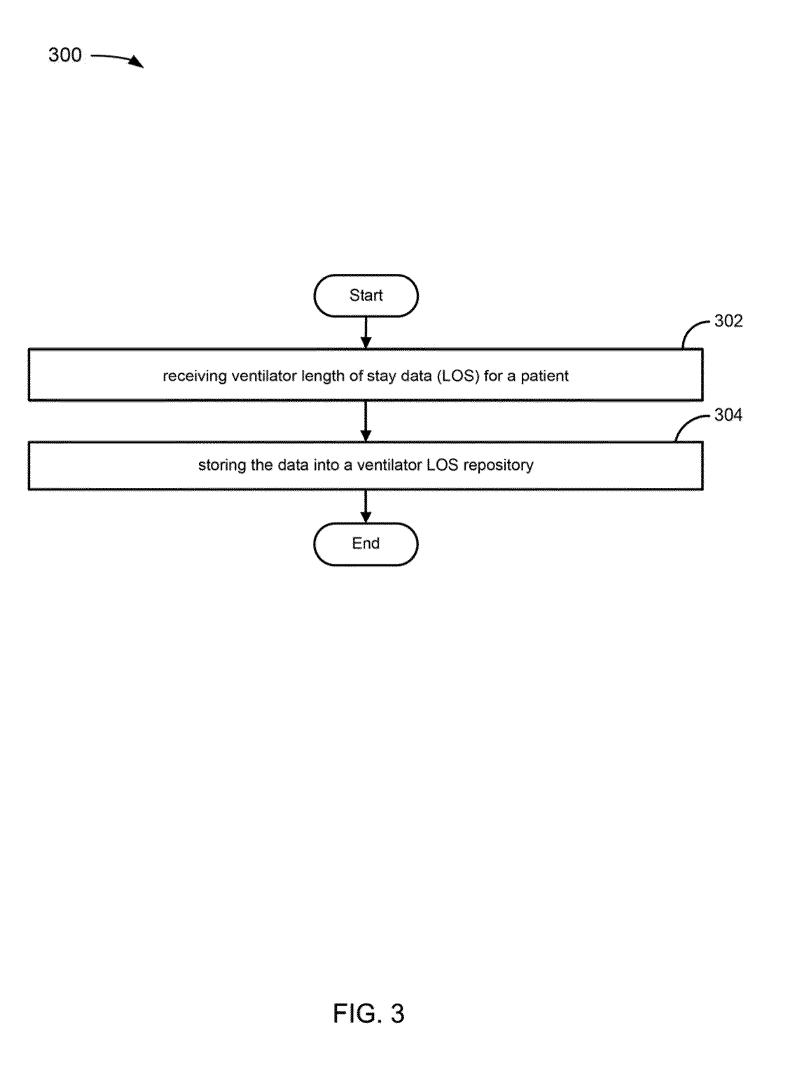

FIG. 3 depicts a flowchart 300 of an example of a method for collecting ventilator LOS data. In the example of FIG. 3, the flowchart starts at module 302 with receiving ventilator length of stay data (LOS) for a patient. A ventilator data interface can collect data from one or more healthcare facilities.

Examples of data points that a ventilator data interface can collect include, by way of example: Patient First Name, Patient Last Name, Patient Date Of Birth, Patient Gender, Medical Record Number, On Ventilator Date, On Ventilator Time, Off Ventilator Date, Off Ventilator Time, Physician, ICU Type, Diagnosis Codes defining the patient diagnosis, Event Disposition defining the survival or expiration of the patient following the stay on the ventilator, various Label(s) for describing data, measures, and interventions as independent variables. Create Time to identify the time of creation of the record, Create User to identify the user creating the record, Update Time to identify the time of any update to the record, Update User to identify a user making an update to the record.

In the example of FIG. 3, the flowchart continues to module 304 with storing the data into a ventilator (LOS) repository. The data points collected this method can be saved into a data structure within a repository and/or directly into a data repository in any known or convenient format. For example, the data can be stored into tables of a database within the repository having a schema delineated by the data types used by the healthcare facility collecting and or using the data. Various associations can be made. The data can be stored in association with a patent identifier such as to identify the patient from which the data was collected as well as an identifier for the healthcare facility providing the ventilator. Having stored the data into a ventilator (LOS) repository, the flowchart terminates.

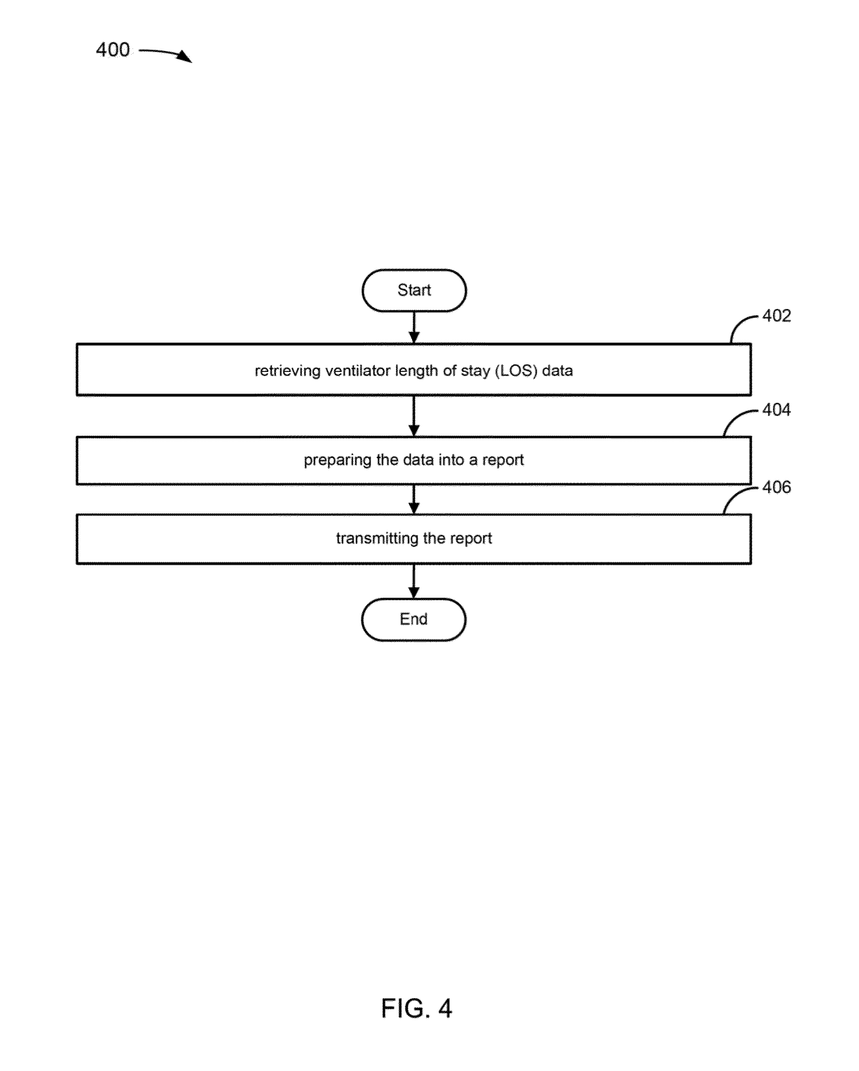

FIG. 4 depicts a flowchart 400 of an example of a method for preparing reports of ventilator LOS data. In the example of FIG. 4, the flowchart starts at module 402 with retrieving ventilator length of stay (LOS) data. This data can be retrieved from a data repository storing the data in any known or convenient manner. For example, the data can be retrieved through one or more sequel queries to the data repository returning information in accordance with criteria specified by a user or automated process requesting the report.

In the example of FIG. 4, the flowchart continues to module 404 with preparing the data into a report. The report can then be formatted in accordance with the aesthetic requirements of a user or target audience and with respect to one or more criteria specified by the user or target audience. The format can vary as to the specific requirements of the requesting party, and may include data, diagrams, charts and other derivative uses of the data as formatted for the view and understanding of the user or target audience that will review the report.

In the example of FIG. 4, the flowchart continues to module 406 with transmitting the report. Here the finished report can be provided to the user electronically using on or more data transport technologies. For example, XML, HTML, XHTML or another known or convenient technology can be used to transfer the report to its requestor. Having transmitted the report, the flowchart terminates.

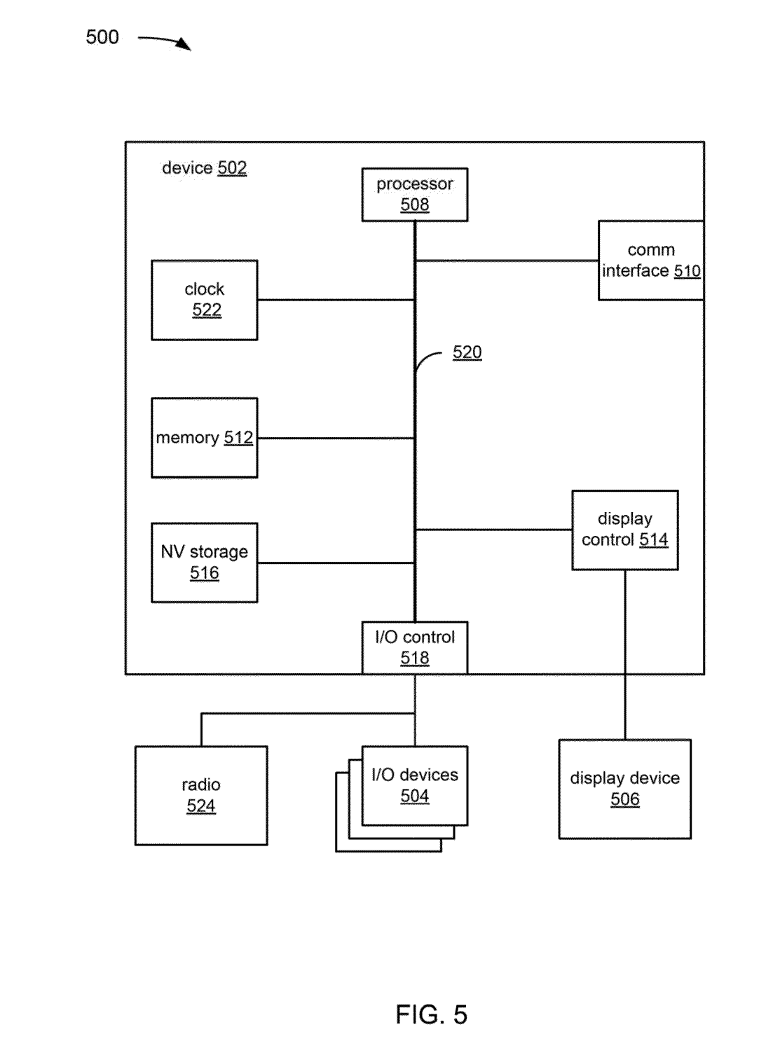

FIG. 5 depicts an example of a system 500 for performing healthcare data analysis. The system 500 includes a device 502, I/O devices 504, and a display device 506. The device 502 includes a processor 508, a communications interface 510, memory 512, display controller 514, non-volatile storage 516, I/O controller 518, clock 522, and radio 524. The device 502 maybe coupled to or include the I/O devices 504 and the display device 506.

The device 502 interfaces to external systems through the communications interface 510, which may include a modem or network interface. It will be appreciated that the communications interface 510 can be considered to be part of the system 500 or a part of the device 502. The communications interface 510 can be an analog modem, ISDN modem or terminal adapter, cable modem, token ring IEEE 802.5 interface, Ethernet/IEEE 802.3 interface, wireless 802.11 interface, satellite transmission interface (e.g., “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 508 may be, for example, a conventional microprocessor such as an Intel Pentium microprocessor or Motorola power PC microprocessor. The memory 512 is coupled to the processor 508 by a bus 520. The memory 512 can be Dynamic Random Access Memory (DRAM) and can also include Static RAM (SRAM). The bus 520 couples the processor 508 to the memory 512, also to the non-volatile storage 516, to the display controller 514, and to the I/O controller 518.

The I/O devices 504 can include a keyboard, disk drives, printers, a scanner, and other input and output devices, including a mouse or other pointing device. The display controller 514 may control in the conventional manner a display on the display device 506, which can be, for example, a cathode ray tube (CRT) or liquid crystal display (LCD). The display controller 514 and the I/O controller 518 can be implemented with conventional well known technology.

The non-volatile storage 516 is often a magnetic hard disk, flash memory, an optical disk, or another form of storage for large amounts of data. Some of this data is often written, by a direct memory access process, into memory 512 during execution of software in the device 502. One of skill in the art will immediately recognize that the terms “machine-readable medium” or “computer-readable medium” includes any type of storage device that is accessible by the processor 508.

Clock 522 can be any kind of oscillating circuit creating an electrical signal with a precise frequency. In a non-limiting example, clock 522 could be a crystal oscillator using the mechanical resonance of vibrating crystal to generate the electrical signal.

The radio 524 can include any combination of electronic components, for example, transistors, resistors and capacitors. The radio is operable to transmit and/or receive signals.

The system 500 is one example of many possible computer systems which have different architectures. For example, personal computers based on an Intel microprocessor often have multiple buses, one of which can be an I/O bus for the peripherals and one that directly connects the processor 508 and the memory 512 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 512 for execution by the processor 508. A typical computer system will usually include at least a processor, memory, and a bus coupling the memory to the processor.

In addition, the system 500 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 516 and causes the processor 508 to execute the various acts required by the operating system to input and output data and to store data in memory, including storing files on the non-volatile storage 516.

Virtualized computers are another type of computing system that can be used to provide one or more of the components identified in reference to system 500, if not the system 500 and all of the components included therein. In a virtualized environment a virtual machine acts like a physical computer, but is generated through execution of software on more or more processors as a program. At times, more than one virtual machine is executed on common hardware providing system 500 as well as other systems. If a virtualized machine is used then references in this section may refer to virtualized hardware components rather than actual physical components.

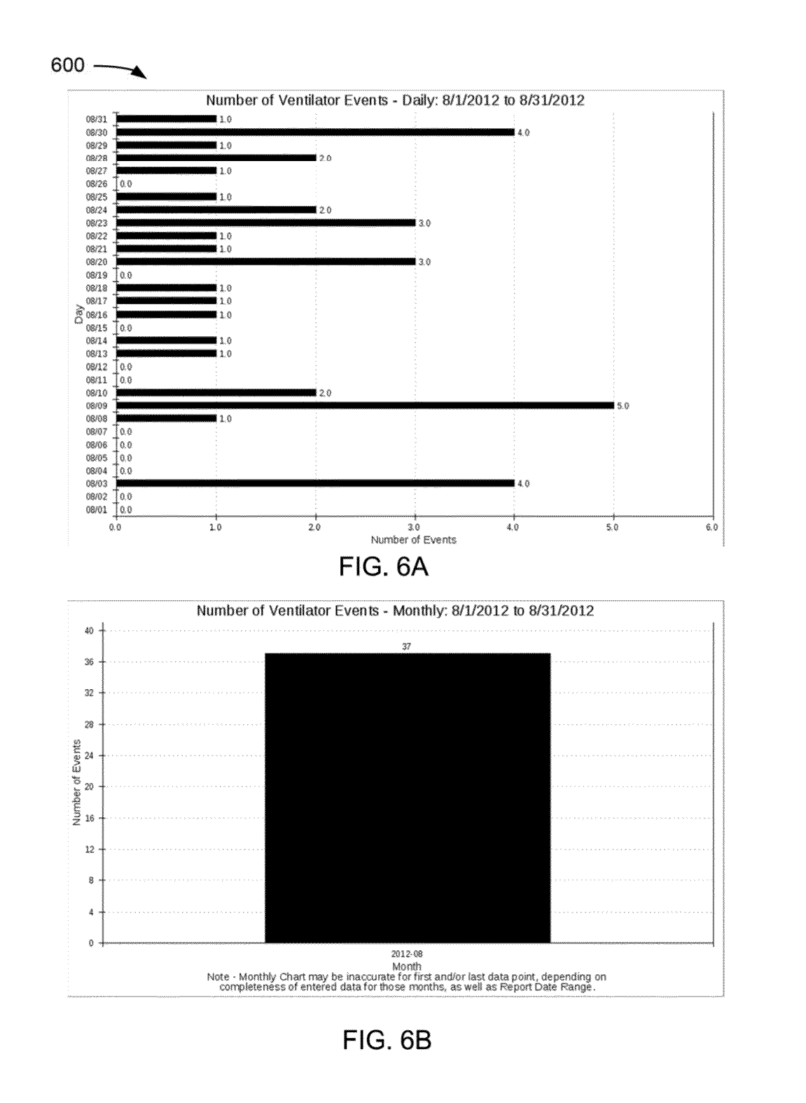

FIG. 6A depicts a graph of a number of ventilator events. The information depicted can be generated as a part of a report useful to analyze the day by day activity of the use of a ventilator.

FIG. 6B depicts a graph of a number of ventilator events. Such can be generated over a range of time, e.g. days, months or years, and incorporated in to a report useful for analyzing data from one or more healthcare facilities.

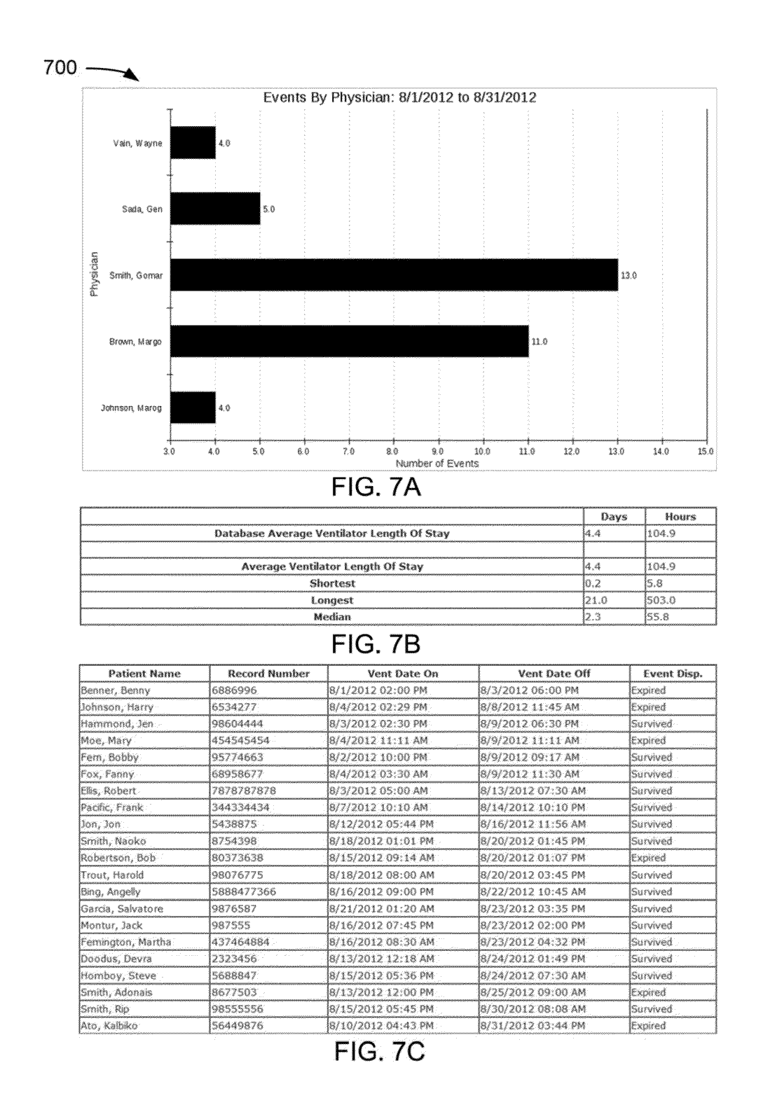

FIG. 7A depicts a graph of a number of events by physician. This form of data can be used to provide analysis of ventilator use by various doctors. Particularly, performance abnormalities can be identified by comparing the use statistics for one doctor as compared against an average of doctors over one or more healthcare facilities.

FIG. 7B depicts a chart of average ventilator length of stay. This information can be used in a report to benchmark one healthcare facility against another, such as to identify healthcare facilities' efficiency in the use of ventilators.

FIG. 7C depicts a chart of patient data. The chart includes patient name, record number, vent date on (the day the ventilator use began), vent date off (the day ventilator use ceased), and the event disposition (where expired is defined as deceased and survived is defined as living after being taken off the ventilator). The data can be incorporated into reports or used as the basis for further analysis and charting.

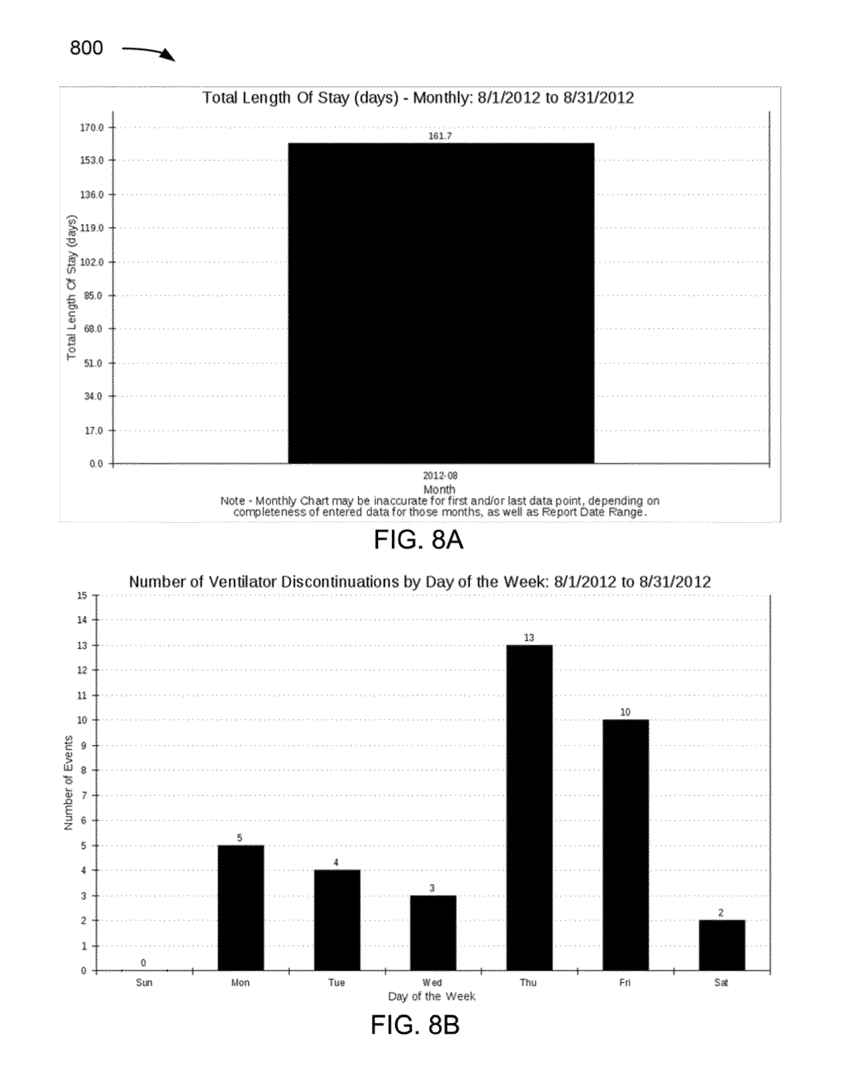

FIG. 8A depicts a graph of total length of stay. The chart shows the number of days spent on a ventilator across all patients in a particular healthcare facility over a specified range of time.

FIG. 8B depicts a graph of number of ventilator discontinuations by day of week. This chart can be useful for identifying the frequency at which patients are removed from ventilators, particularly whether there are any particular days on which patients are more likely to be removed from a ventilator. This data can be included in a report and can be based off of various time frames and over different sets of healthcare facilities.

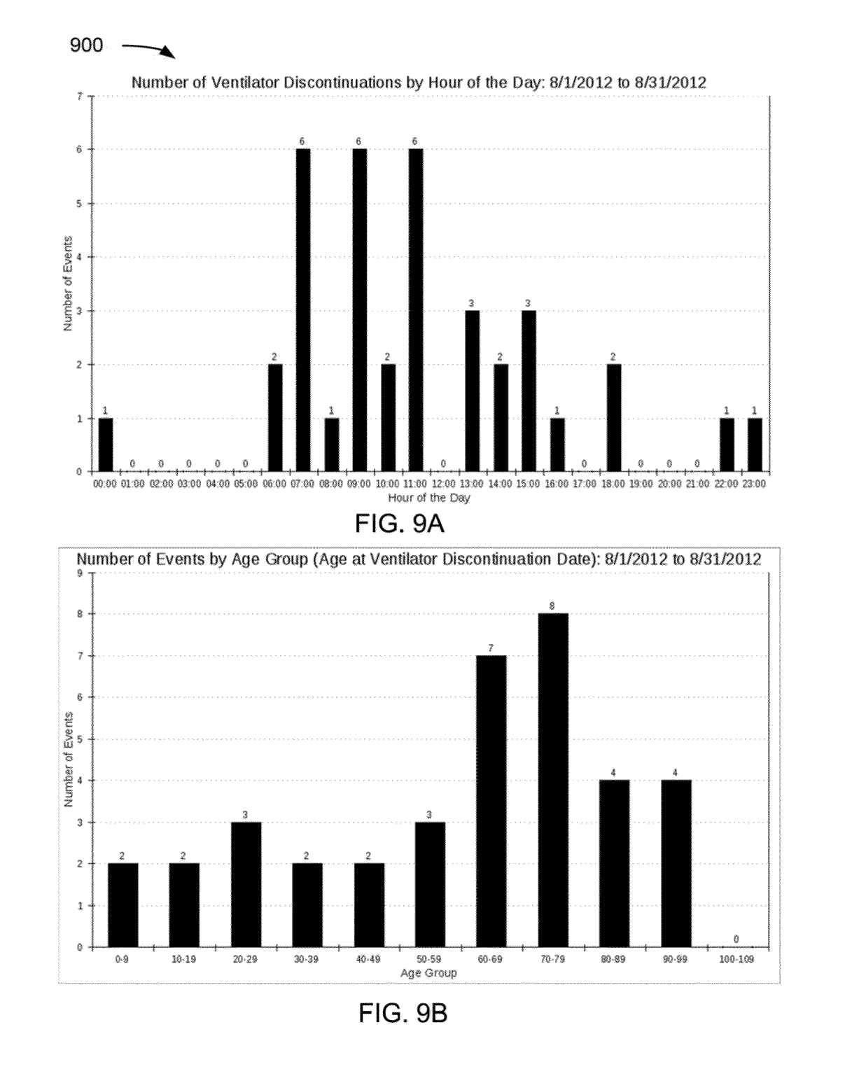

FIG. 9A depicts a chart of number of ventilator discontinuations by hour of the day. This chart can be used to identify patterns as to the time of day that patients are removed from ventilators. Such can be included in various reports.

FIG. 9B depicts a chart of number of events by Age Group. This chart can be used to identify correlations between age and events as well as other analysis points.

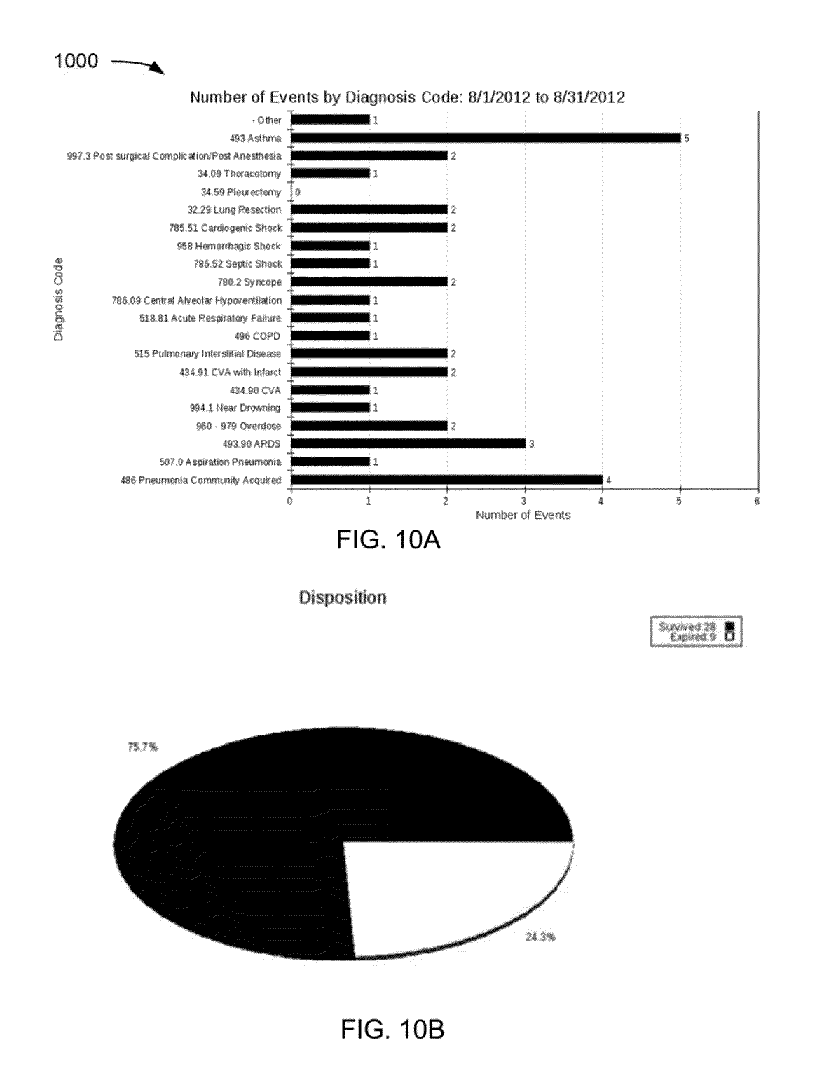

FIG. 10A depicts a chart of number of events by diagnosis code. This chart identifies the various events that patients experience, including the kinds of events such as asthma, post-surgical complication, thoracotomy, pleurectomy, lung resection, cardiogenic shock, hemorrhagic shock, septic shock, syncope, central alveolar hypoventilation, acute respiratory failure, COPD, pulmonary interstitial disease, CVA with infarct, CVA, near drowning, overdose, ARDS, aspiration pneumonia, and pneumonia community acquired. However, other diagnosis can be analyzed as well.

FIG. 10B depicts a chart of disposition of patient disposition following use of a ventilator. This chart is provided over a course of time to indicate a percentage of patients that survived their stay on the ventilator and identify the percentage of patients that did not.

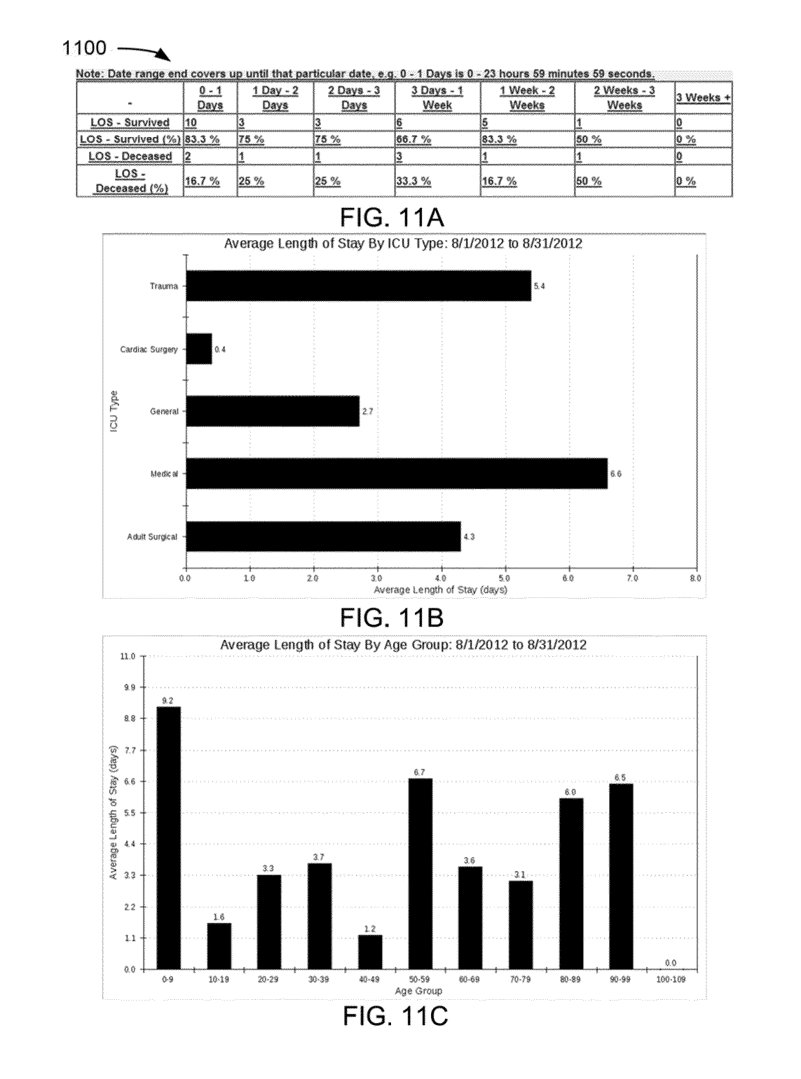

FIG. 11A depicts an example of a chart of patient disposition following use of a ventilator. This organization of data can be used in a report for analyzing the survival rate relative to the number of days spent on the ventilator.

FIG. 11B depicts an example of a chart of average length of stay by ICU type. This kind of chart can organize data by the types of healthcare facility in which the ventilators are located. Similarly it can be used to identify the types of health care facilities that require longer or shorter stays on ventilators, on average.

FIG. 11C depicts an example of a chart of average length of stay by age group. This chart can be used to show the length of stay on a ventilator by the age of the patient. The chart can be used to identify the age groups that incur longer or shorter stays on a ventilator.

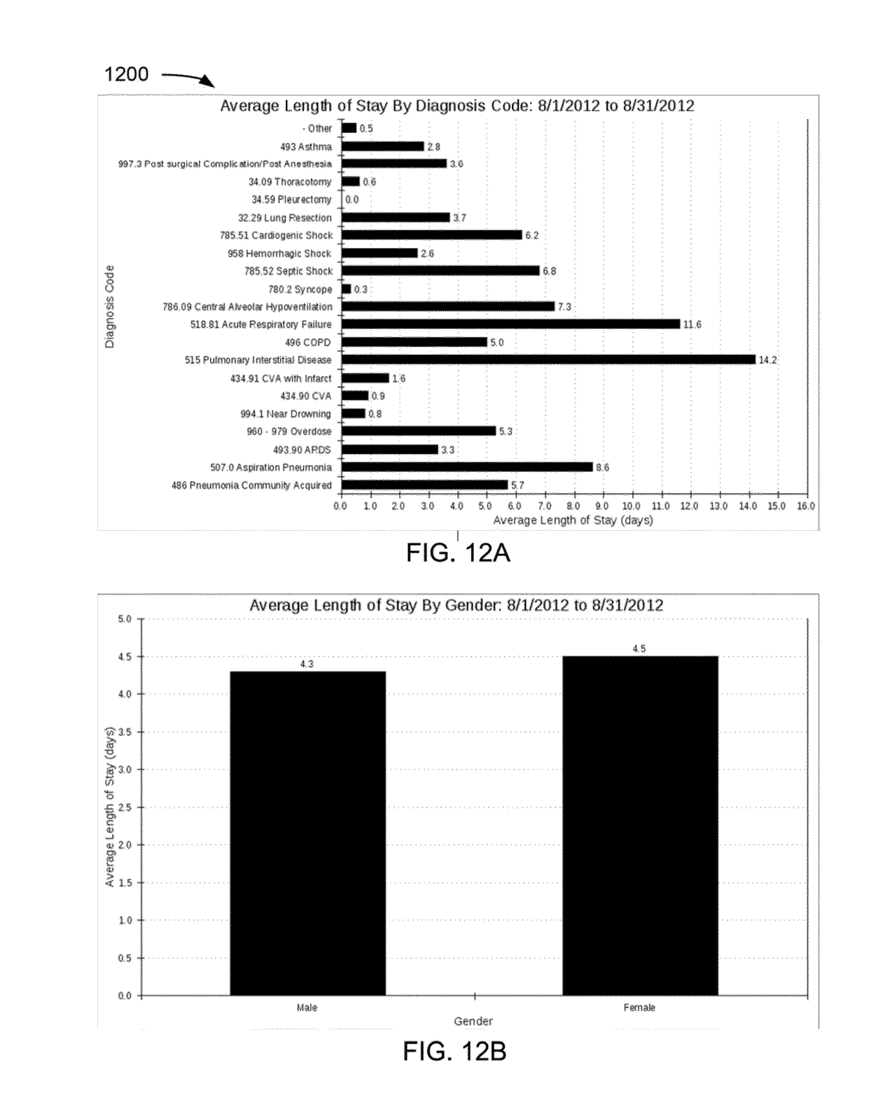

FIG. 12A depicts an example of a chart of average length of stay by diagnosis code. This data can be used to identify the longer or shorter stays on a ventilator by the diagnosis of the patient. This can be used to better plan for various diagnoses.

FIG. 12B depicts an example of a chart of average length of stay by gender. This chart can identify longer or shorter stays across various healthcare facilities by gender over different time frames.

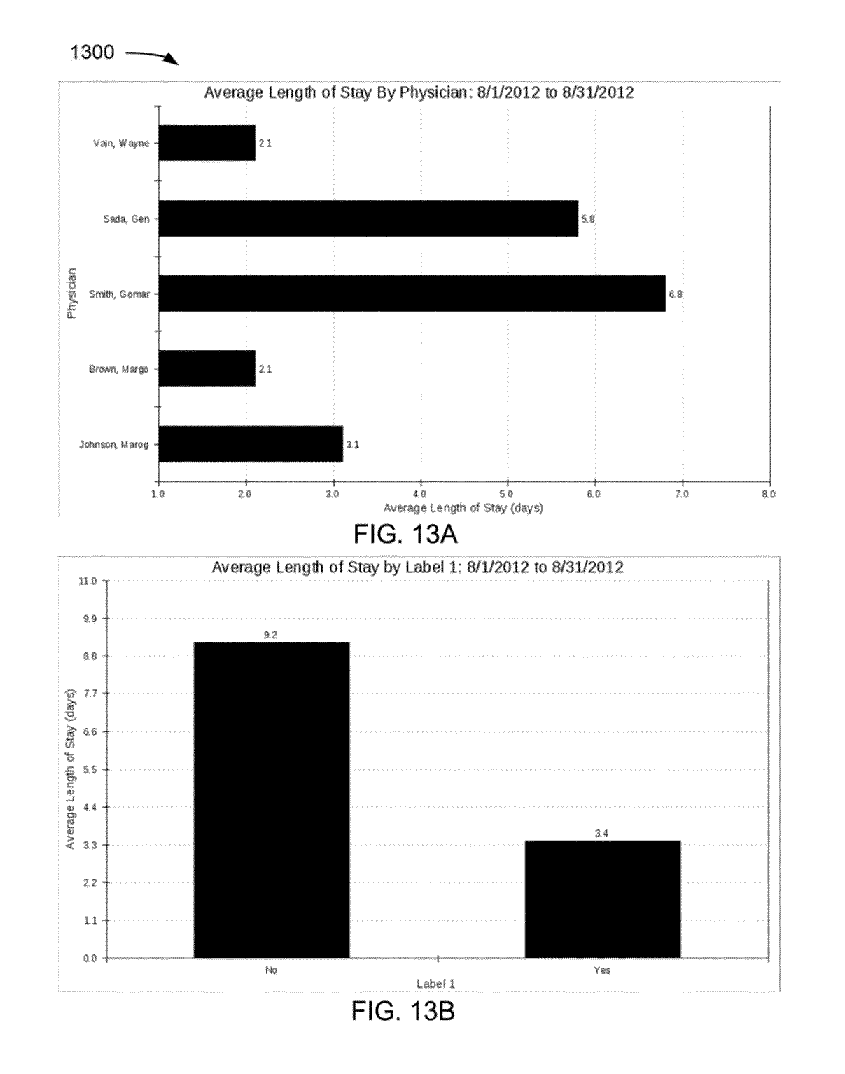

FIG. 13A depicts an example of a chart of average length of stay by physician. This chart defines the length of use of ventilators by various doctors. It may be that some doctors allow their patients to remain on a ventilator for a longer or shorter amount of time than other doctors. The chart can be used to compare doctors against an average of doctors over one or more healthcare facilities.

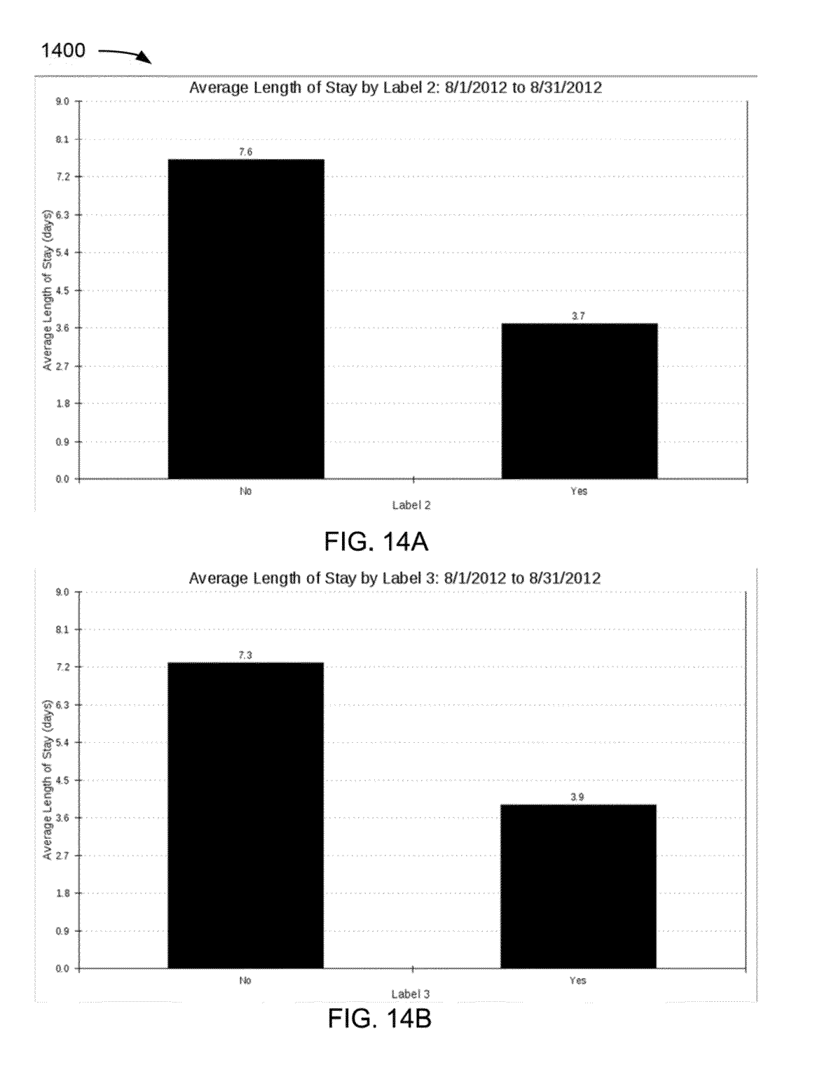

FIGS. 13B, 14A, and 14B depict examples of average length of stay by user defined independent variable, e.g., trial of anti-microbial coated endotracheal tube to reduce infection, implementation of a new type of ventilator, mode or setting, initiation of change in ventilator patient management protocol, testing an innovative ventilator weaning parameter such as P0.1, changing use of sedation during mechanical ventilation or another known or convenient independent variable.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a ventilator data interface operable to receive ventilator length of stay (LOS) data for a patient on a mechanical ventilator at a healthcare facility; wherein the healthcare facility is collecting the ventilator LOS data into a ventilator LOS repository for use in providing ventilator LOS statistics and reports across multiple healthcare facilities;
a ventilator data management engine coupled to the ventilator data interface; wherein the ventilator data management engine stores the ventilator LOS data repository in association with the healthcare facility and with the patent;
a ventilator LOS data repository coupled to the ventilator data engine; wherein the ventilator LOS data repository is operable to store the ventilator LOS data in association with the healthcare facility and the patient; and
a ventilator data reports processing engine coupled to the ventilator LOS data repository; wherein the ventilator data reports processing engine is operable to produce one or more reports of ventilator LOS data.

2. The system of claim 1, wherein the reports processing engine produces an inter-institutional report using ventilator LOS as a dependent variable.

3. The system of claim 1, wherein the reports processing engine produces an intra-institutional report using ventilator LOS as a dependent variable.

4. The system of claim 1, wherein the reports processing engine produces a report based on event disposition.

5. A method comprising:
receiving, via a ventilator data interface coupled to a processor executing instructions in memory, ventilator length of stay (LOS) data for a patient; wherein the data is received in accordance with access control provided by a user management engine; and
storing the data into a ventilator LOS data repository; wherein the ventilator LOS data associates the patient with a healthcare facility.

6. The method of claim 5, wherein the ventilator LOS data associates the patient with the length of stay on the ventilator using ventilator LOS as a dependent variable.

7. The method of claim 5, wherein the ventilator LOS data associates the patient with the event disposition from the stay on the ventilator using ventilator LOS as a dependent variable.

8. A method comprising:
retrieving, via a ventilator data reports processing engine coupled to a processor executing instructions in memory, ventilator data from a ventilator length of stay (LOS) data repository in accordance with a request for a report on ventilator LOS data;
preparing the data into a ventilator length of stay data report in accordance with the request; wherein the request specifies one or more criteria by which to prepare the report; and
transmitting the ventilator LOS report via a ventilator data interface.

9. The method of claim 8, wherein the request for the report specifies that the criteria on which the report should be prepared is the event disposition, particularly whether the patient survived or expired.

10. The method of claim 8, wherein the request for the report specifies criteria for selection based on a size of a healthcare facility in which the ventilator LOS data was generated.

11. The method of claim 8, wherein the request for the report specifies criteria for selection based on an ICU type specifying the nature of the ICU across healthcare facilities generating the ventilator LOS data.
